(19) United States
(12) Patent Application Publication
(10) Pub. No.: US 2009/0027773 A1
(43) Pub. Date: Jan. 29, 2009

(54) WIRE GRID TYPE POLARIZATION ELEMENT, MANUFACTURING METHOD THEREOF, LIQUID CRYSTAL DEVICE, AND PROJECTION TYPE DISPLAY APPARATUS

(75) Inventor: Yasushi Kawakami, Chino-shi (JP)

Correspondence Address: LOWE HAUPTMAN HAM & BERNER, LLP, 1700 DIAGONAL ROAD, SUITE 300, ALEXANDRIA, VA, 22314, US

(73) Assignee: SEIKO EPSON CORPORATION, Tokyo (JP)

(21) Appl. No.: 12/145,229

(22) Filed: Jun. 24, 2008

(30) Foreign Application Priority Data
Jul. 25, 2007 (JP) 2007-192990

(51) Int. Cl. G02B 5/30; B29D 11/00

(52) U.S. Cl. 359/486; 216/24

(57) ABSTRACT

There is provided a wire grid type polarization element equipped with a plurality of lines of metal grid on a translucent substrate. A plurality of lines of groove like concave portions are formed on the substrate, and the metal grid is embedded in the plurality of lines of groove like concave portions.

### BACKGROUND

1. Technical Field

The present invention relates to a wire grid type polarization element, a manufacturing method thereof, a liquid crystal device, and a projection type display apparatus.

2. Related Art

As shown in FIGS. 7A, 7b, a wire grid type polarization element 1A is equipped with a plurality of lines of metal grid 20A on a substrate surface of a translucent substrate 10A. When a pitch (period) of the metal grid 20A is shorter than a wavelength of incident light, a polarization component that vibrates in the direction perpendicular to the longitudinal direction of the metal grid 20A is transmitted whereas a polarization component that vibrates in the direction parallel to the longitudinal direction of the metal grid 20A is reflected.

In the past, the wire grid type polarization element 1A is manufactured by forming a metal film on the substrate surface of the translucent substrate 10A, and thereafter forming an etching mask that is equipped with groove like openings in areas in which the metal grid 20A should be formed on the surface of the metal film, and patterning the metal film in this state.

Further, when forming the etching mask, a method has been proposed in which a resin is applied on the surface of the metal film, and thereafter transferring a concave-convex pattern formed on a mold member on the resin to obtain a resist mask that is equipped with groove like openings in areas in which the metal grid 20A should be formed (see JP-A-2006-84776).

In the wire grid type polarization element 1A, the metal grid 20A absorbs a part of incident light, so that even when the pitch of the metal grid 20A is shorter than the wavelength of the incident light, it is impossible to transmit the polarization component that vibrates in the direction perpendicular to the longitudinal direction of the metal grid 20A. Accordingly, the capability of the wire grid type polarization element 1A is expressed by “transmittance” and “contrast”. “Transmittance” is a the transmittance of a polarization component that vibrates in the direction perpendicular to the longitudinal direction of the metal grid 20A and “contrast” is a value obtained by dividing the transmittance of the polarization component that vibrates in the direction perpendicular to the longitudinal direction of the metal grid 20A by the transmittance of a polarization component that vibrates in the direction parallel to the longitudinal direction of the metal grid 20A.

Herein, in order to increase the “contrast”, it is required that the pitch of the metal grid 20 is considerably shorter than the wavelength of the incident light. In order to enhance the “transmittance” it is required that the width size of the metal grid 20 is narrowed and the width size and the thickness size of the metal grid 20 have to satisfy a predetermined condition.

However, in the method for forming the metal grid 20A by subjecting a metal film to an etching treatment as in the past, the width size and the thickness size of the metal grid 20A are influenced by both of the etching accuracy to the metal film and film thickness accuracy when forming the metal film. Accordingly, there are restrictions that, for example, there is a limit to set the pitch of the metal grid 20A to about 140 nm, and the like. Accordingly, as for “transmittance” and “contrast”, it is a limit to obtain the capability as shown in FIG. 8. Accordingly, there are problems in that the “transmittance” is widely varied in the visible light band, and the like.

Accordingly, when liquid crystal devices using the conventional wire grid type polarization elements 1A are used for a projection type display apparatus as light bulbs respectively corresponding to light of red (R), green (G), and blue (B), there are problems in that, for example, light amount is reduced for the light of red (R), and the like.

### SUMMARY

An advantage of some aspects of the invention is to provided a wire grid type polarization element which makes it possible to improve both of “transmittance” and “contrast”, a manufacturing method thereof, a liquid crystal device equipped with the wire grid type polarization element, and a projection type display apparatus equipped with the liquid crystal device.

According to a first aspect of the invention, there is provided a wire grid type polarization element equipped with a plurality of lines of metal grid on a substrate surface of a translucent substrate. A plurality of lines of groove like concave portions are formed along the metal grid on the substrate surface, and the metal grid is embedded in the plurality of lines of groove like concave portions.

Further, according to a second aspect of the invention, there is provided a manufacturing method of a wire grid type polarization element equipped with a plurality of lines of metal grid on a substrate surface of a translucent substrate. The manufacturing method includes forming an etching mask equipped with groove like openings on the substrate surface before forming the metal grid, the groove like openings being provided in areas in which the metal grid should be formed, forming groove like concave portions in areas overlapping with the groove like openings on the substrate surface by subjecting the substrate surface to an etching treatment, embedding a metal film that should form the metal grid in the groove like concave portions, and leaving the metal film in the groove like concave portions whereas removing the metal film protruded from the groove like concave portions by subjecting the substrate surface to a polishing treatment.

In the first and second aspects of the invention, a plurality of lines of groove concave portions are formed on the substrate surface of the translucent substrate and the metal grid is embedded in the plurality of lines of groove like concave portions. Accordingly, it is not necessary to form the metal grid by etching a metal film. Consequently, the wide size and the pitch of the metal grid are regulated by the width size and the pitch of the groove like concave portions formed on the substrate surface of the translucent substrate and are not influenced by the etching accuracy to the metal film. Consequently, the width size of the metal grid can be reduced to not more than 70 nm, for example, to 35 nm, and the pitch of the metal grid can be reduced to not less than 140 nm, for example, to 70 nm. Further, the thickness size of the metal grid is regulated by the depth of the groove like concave portions formed on the substrate surface of the translucent substrate and is not influenced by the accuracy of the film thickness when the metal film is formed. Consequently it is also possible that the ratio of the thickness size and the width size of the metal grid can be precisely set to, for example, 1:1. Consequently, both of “transmittance” and “contrast” of the wire grid type polarization element can be improved.

It is preferable that transmittance of a polarization component that vibrates in a direction perpendicular to a longitudinal direction of the metal grid is not less than 80% over the entire range of a wavelength band of from 460 nm to 780 nm in the first aspect of the invention.

It is preferable that a translucent protecting layer is formed on the substrate surface in the first aspect of the invention. In the wire grid type polarization element to which the invention is applied, the metal grid is embedded in the plurality of lines of groove like concave portions formed on the substrate surface. Accordingly, the substrate surface is smooth. Consequently, a translucent protecting layer can be easily formed on the substrate surface to have an even thickness.

It is preferable that a reflection preventing layer is formed on at least one of both surfaces of the translucent substrate in the first aspect of the invention. The formation of the reflection preventing layer can improve “transmittance” of the wire grid type polarization element as reflectance loss can be reduced.

In the manufacturing method of a wire grid type polarization element according to the second aspect of the invention, the etching mask is formed by performing exposure and development after a photosensitive resin is applied on the substrate surface. In the second aspect of the invention, “exposure” is not limited the exposure performed by ultra violet, and “exposure” means to include the exposure performed by extreme ultra violet, electron beam, X-ray, and the like.

In the manufacturing method of a wire grid type polarization element according to the second aspect of the invention, it is also preferable that a mask material layer is formed on the substrate surface, and thereafter a die surface of a mold member equipped with projections at portions corresponding to the groove like openings is pressed to the mask material layer to transfer a formation pattern of the projections to the mask material layer, thereby forming the etching mask in which thicknesses of the groove like portions are reduced. According to the method, the etching mask can be formed without excessive labor hour and an expensive device for exposure, development, or the like.

It is preferable that a chemical mechanical polishing treatment is performed as the polishing treatment in the manufacturing method of a wire grid type polarization element according to the second aspect of the invention. With the chemical mechanical polishing, the metal film protruded from the concave portions can be removed and the substrate surface itself can be also polished. Accordingly, the substrate surface can be finished to a smooth surface.

The wire grid type polarization element according to the first aspect of the invention can be used for, for example, a liquid crystal device. The liquid crystal device can be used as a display unit of an electronic apparatus such as a mobile computer, a cellular phone, or the like, and can be used as a light bulb of a projection type display apparatus. The projection type display apparatus includes a light source unit for introducing light into the liquid crystal device, and a projection optical system for expansively projecting light optically modulated by the liquid crystal device. Accordingly, the projection type display apparatus can optically modulate the light emitted from the light source unit by the liquid crystal device and can expansively project the optically modulated light by the projection optical system.

In the invention, a structure may be employed in which the three liquid crystal devices are used for the projection type display device as light bulbs corresponding to each of red (R), green (G), and blue (B). Further, a structure may be employed in which the light emitted from the light source unit is optically modulated by the liquid crystal device in which a color filter is incorporated to expansively project the optically modulated light by the projection optical system. In both of the liquid crystal devices, high transmittance can be obtained with respect to any color light of red (R), green (G), and blue (B) if the wire grid type polarization element to which the invention is applied. Accordingly, a color image having a high quality can be displayed.

### BRIEF DESCRIPTION OF THE DRAWINGS

The invention will be described with reference to the accompanying drawings, wherein like numbers reference like elements.

FIGS. 1A and 1B are a cross sectional view and a plan view schematically showing a structure of a wire grid type polarization element to which the invention is applied.

FIGS. 2A to 2G are process cross sectional views showing a manufacturing method of the wire grid type polarization element to which the invention is applied.

FIGS. 3A to 3G are process cross sectional views showing another manufacturing method of the wire grid type polarization element to which the invention is applied.

FIG. 4 is a graph showing transmittance property and contrast property of the wire grid type polarization element to which the invention is applied.

FIGS. 5A and 5B are a cross sectional view and a plan view schematically showing a structure of another wire grid type polarization element to which the invention is applied.

FIGS. 6A and 6B are each a configuration diagram of a projector to which the invention is applied.

FIGS. 7A and 7B are a cross sectional view and a plan view schematically showing a structure of a conventional wire grid type polarization element.

FIG. 8 is a graph showing transmittance property and contrast property of the conventional wire grid type polarization element.

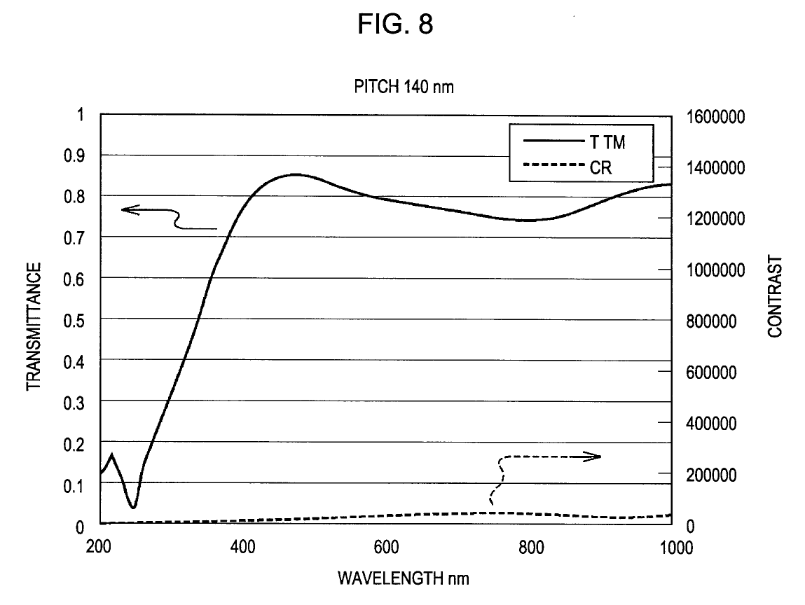

### DESCRIPTION OF EXEMPLARY EMBODIMENTS

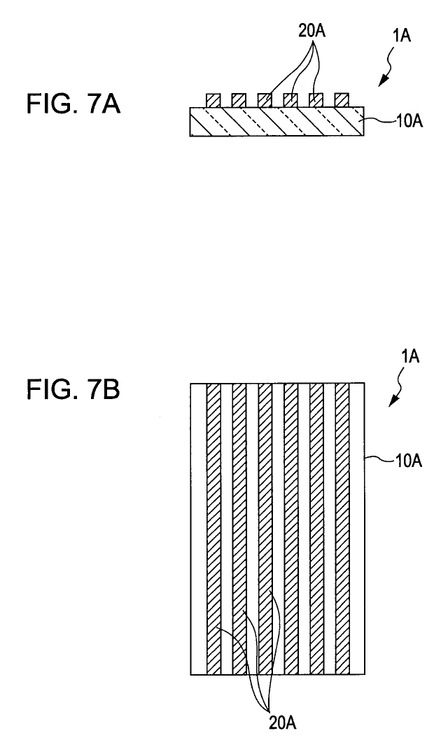

Hereinafter, an embodiment of the invention will be described. In the drawings to be referred to in the following description, a scale size is changed for every layer or every member in order to make each layer and each member recognizable in the drawings. Note that in the following description, the same reference numeral is used to dente the same element so as to make it easy to recognize the distinction with respect to the structure described with reference to FIGS. 7A and 7B.

### Wire Grid Type Polarization Element to Which Invention is Supplied

### Structure of Grid Type Polarization Element

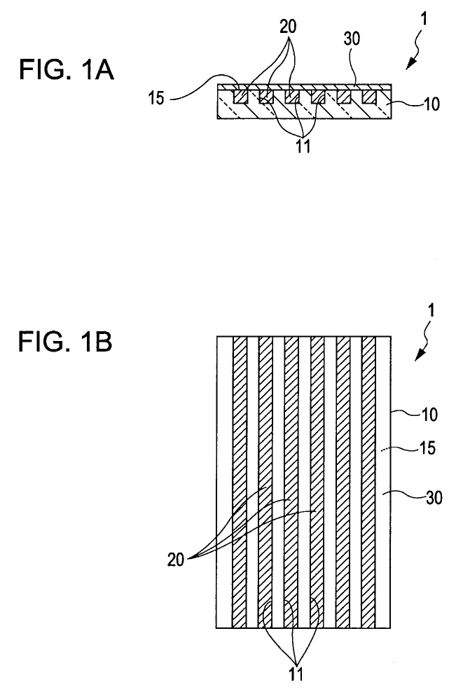

FIGS. 1A and 1B are a cross sectional view and a plan view schematically showing a structure of a wire grid type polarization element to which the invention is applied.

In FIGS. 1A and 1B, a wire grid type polarization element 1 of the embodiment is equipped with a plurality of lines of metal grid 20 on a substrate surface 15 of a translucent substrate 10 made of a quartz glass, a heat resistance glass, or the like. The metal grid 20 is constituted by a metal film having light blocking effect formed by, for example, a single layer film or a multi-layer film of silver, gold, copper, palladium, platinum, aluminum, rhodium, silicon, nickel, cobalt, manganese, iron, chrome, titanium, ruthenium, niobium, neodymium, ytterbium, yttrium, molybdenum, tungsten, indium, bismuth, or an alloy thereof.

In the wire grid type polarization element 1 of the embodiment, a plurality of lines of grove like concave portions 11 are formed along the metal grid 20 on the substrate surface 15, and metal grid 20 is embedded in the plurality of lines of grove like concave portions 11. Accordingly in the wire grid type polarization element 1, the substrate surface 15 of the translucent substrate 10 constitutes a smooth surface in which both of areas in which the metal grid 20 is formed and areas in which the metal grid 20 is not formed are alternately continued.

In the embodiment, both of the width size of the metal grid 20 (opening width size of groove like concave portion 11) and the distance of the lines of the metal grid 20 are 35 nm, and the pitch of the lines of the metal grid 20 is 70 nm in the wire grid type polarization element 1. Further, the thickness size of the metal grid 20 (depth size of the groove like concave portions 11) is also 35 nm, and the aspect ratio of the cross section of the metal grid (aspect ratio of the groove like concave portion 11) is 1:1.

Further, in the wire grid type polarization element 1 of the embodiment, a surface protecting layer 30 made of a metal oxide film such as a silicon oxide film, a metal nitride film such as a silicon nitride film, or the like is formed on the substrate surface 15 of the translucent substrate 10.

In the wire grid type polarization element 1 structured in this manner, when the pitch (period) of the metal grid 20 is shorter than a wavelength of incident light, a polarization component (for example, P polarization component) that vibrates in the direction perpendicular to the longitudinal direction of the metal grid 20 is transmitted, whereas a polarization component (for example, S polarization component) that vibrates in the direction parallel to the longitudinal direction of the metal grid 20 is reflected.

### Manufacturing Method of Wire Grid Type Polarization Element

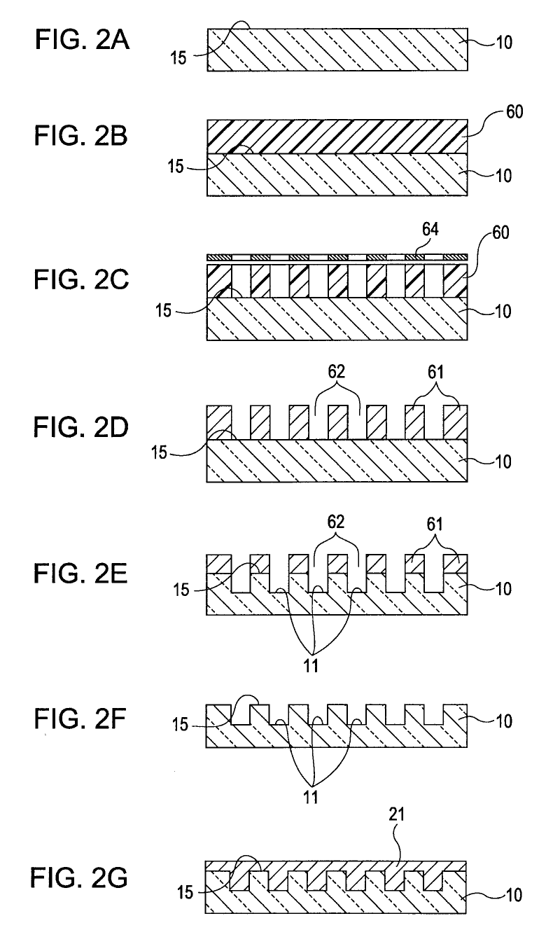

Hereinafter, the structure of the wire grid type polarization element 1 of the embodiment will be described in detail with a manufacturing method of the wire grid type polarization element 1 of the embodiment with reference to FIGS. 2A to 2G. FIGS. 2A to 2G are process cross sectional views showing a manufacturing method of the wire grid type polarization element 1 to which the invention is applied.

In order to manufacture the wire grid type polarization element 1 of the embodiment, first, the translucent substrate 10 whose both surfaces are smooth is prepared as shown in FIG. 2A.

Then, a mask forming process for forming an etching mask on the substrate surface 15 among the both surfaces of the translucent substrate 10 which becomes the light incident surface of the wire grid type polarization element 1 is performed.

In order to form an etching mask, a photosensitive resin 60 is applied on the substrate surface 15 of the translucent substrate 10 as shown in FIG. 2B, and thereafter exposing the photosensitive resin 60 via an exposure mask 64 as shown in FIG. 2C. Then, the photosensitive resin 60 is developed, and thereafter performing a baking process to form an etching mask 61 (resist mask) that is equipped with groove like openings 62 in the areas in which the metal grid 20 should be formed as shown in FIG. 2D. Herein, the opening width sizes of the groove like openings 62 are 35 nm, and the distances of the portions positioned between the groove like openings 62 are 35 nm. Accordingly, the pitch of the groove like openings 62 is 70 nm. In FIG. 2C, the etching mask 61 is formed by emitting ultra violet to the photosensitive resin 60 of a positive type via the exposure mask 64. However, note that extreme ultra violet may be used as the ultra violet. Further, the photosensitive resin may be exposed by electron beam, X-ray, or the like instead of the ultra violet. In this case, the photosensitive resin 60 may be directly exposed without using the exposure mask 64.

Next, as shown in FIG. 2E, an etching is performed on the substrate surface 15 of the translucent substrate 10 in the state where the etching mask 61 is formed on the substrate surface 15 of the translucent substrate 10 to form the groove like concave portions 11. In the embodiment, as for the etching, an anisotropic dry etching, for example, a reactive ion etching is performed by using an etching gas containing fluorine and oxygen. As a result, the portions of the substrate surface 15 exposed by the groove like openings 62 of the etching mask 61 are etched to have depths of 35 nm and the groove like concave portions 11 are formed. On the other hand, the etching mask 61 is also etched and the thickness thereof is reduced.

Next, the etching mask 61 is removed from the substrate surface 15 of the translucent substrate 10 as shown in FIG. 2F, and thereafter a metal film 21 for forming the metal grid 20 is formed on the entire surface of the substrate surface 15 to perfectly embed the groove like concave portions 11 with the metal film 21 as shown in FIG. 2G. At this time, the metal film 21 is formed outside the groove like concave portions 11. In the embodiment, as for the metal film 21, for example, a single layer film of silver, gold, copper, palladium, platinum, aluminum, rhodium, silicon, nickel, cobalt, manganese, iron, chrome, titanium, ruthenium, niobium, neodymium, ytterbium, yttrium, molybdenum, tungsten, indium, bismuth, or an alloy thereof, or a multi-layer film of the metals is formed to have a film thickness of not less than 35 nm by a vacuum evaporation method, a sputtering method, or the like.

Next, a polishing process is performed on the substrate surface 15 of the translucent substrate 10. The metal film 21 is left in the groove like concave portions 11, whereas the metal film 21 protruded from the concave portions 11 is removed to form the metal grid 20 as shown in FIGS. 1A, 1B. In the embodiment, a chemical mechanical polishing is performed in the polishing process. In the chemical mechanical polishing, a smooth polished surface can be obtained at a high speed by an acting of a chemical component contained in a polishing solution and the relative movement of a polishing agent and the translucent substrate 10. To be more specific, polishing is performed by relatively rotating a machine platen to which an abrasive cloth (pad) formed by a nonwoven cloth, foamed polyurethane, a porous fluorine resin, and the like is attached and a folder for holding the translucent substrate 10 by a polishing device. During the polishing, a polishing agent containing, for example, cerium oxide particles whose average granular size is 0.01 to 20 μm, acrylic acid ester derivative as a dispersing agent, and water is supplied between the abrasive cloth and the substrate surface 15 of the translucent substrate 10. Note that in the embodiment, the substrate surface 15 of the translucent substrate 10 is slightly polished after performing polishing till the substrate surface 15 of the translucent substrate 10 is exposed.

Next, the surface protecting layer 30 is formed on the substrate surface 15 of the translucent substrate 10. In the embodiment, a metal oxide film such as a silicon oxide film, a metal nitride film such as a silicon nitride film, or the like is used as the surface protecting layer 30 to form the film on the substrate surface 15 by a CVD method or the like.

As the result, the wire grid type polarization element 1 is completed in which the metal grid 20 is embedded in the groove like concave portions 11 formed on the substrate surface 15 of the translucent substrate 10 and the surface protecting layer 30 is formed on the substrate surface 15 of the translucent substrate 10.

### Another Manufacturing Method of Wire Grid Type Polarization Element 1

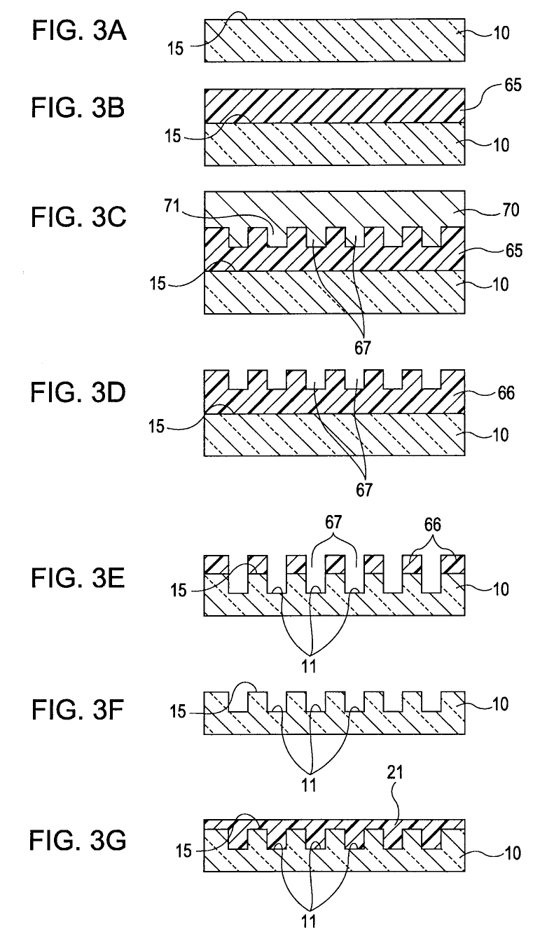

FIGS. 3A to 3G are process cross sectional views showing another manufacturing method of the wire grid type polarization element 1 to which the invention is applied.

First, the translucent substrate 10 whose both surfaces are smooth is prepared as shown in FIG. 3A in order to manufacture the wire grid type polarization element 1 of the embodiment.

Then, a mask forming process for forming an etching mask is performed on the substrate surface 15 among the both surfaces of the translucent substrate 10 which becomes the light incident surface of the wire grid type polarization element 1.

In order to form an etching mask, a photosensitive resin layer as a mask material layer 65 is applied on the substrate surface 15 of the translucent substrate 10 as shown in FIG. 3B, and thereafter a die surface equipped with projections 71 of a mold member 70 for nano printing is pressed to the mask material layer 65 to transfer the formation pattern of the projections 71 to the mask material layer 65 as shown in FIG. 3C. During the transferring, ultra violet is emitted to the mask material layer 65 from the side of the translucent substrate 10 to cure the mask material layer 65. Next, the mold member 70 is pulled away from the side of the translucent substrate 10. As the result, an etching mask 66 equipped with groove like openings 67 that is pressed by the projections 71 to be reduced in the thickness is formed on the substrate surface 15 of the translucent substrate 10 as shown in FIG. 3D. Herein, both of the projections 71 of the mold member 70 and the groove like openings 67 of the etching mask 66 have the size corresponding to the groove like concave portions 11 of the wire grid type polarization element 1 described with reference to FIGS. 1A, 1B. That is, each of the height, width size, and distance of the projections 71 of the mold member 70 is 35 nm, and each of the depth size, opening width size, and distance of the groove like openings 67 of the etching mask 66 is 35 nm.

According to such a method, when forming the etching mask 66, there is an advantage in that a process which requires excessive labor hour and an expensive device for exposure, development, or the like are not required. Note that when a thermosetting resin layer is formed as the mask material layer 65, the mask material layer 65 is cured by heating the mask material layer 65 during the mold member 70 is pressed to the mask material layer 65.

Next, in the state where the etching mask 66 is formed on the substrate surface 15 of the translucent substrate 10, etching is performed on the substrate surface 15 of the translucent substrate 10 to form the groove like concave portions 11. In the embodiment, as for the etching, an anisotropic dry etching is performed by using an etching gas containing oxygen and nitrogen. As the result, the parts of the substrate surface 15 of the translucent substrate 10 corresponding to the groove like openings 67 of the etching mask 66 are exposed. When the etching is continued, the exposed parts of the translucent substrate 10 are etched to have the depth of 35 nm, and the groove like concave portions 11 are formed.

Next, the etching mask 66 is removed from the substrate surface 15 of the translucent substrate 10 as shown in FIG. 3F, and thereafter the metal film 21 for forming the metal grid 20 is formed on the entire surface of the substrate surface 15 to perfectively embed the metal film 21 into the groove like concave portions 11 by the metal film 21 as shown in FIG. 3G. As the result, the metal film 21 is also formed outside the groove like concave portions 11.

Next, a polishing process is performed on the substrate surface 15 of the translucent substrate 10. The metal film 21 is left in the groove like concave portions 11, whereas the metal film 21 protruded from the concave portions 11 is removed to form the metal grid 20 as shown in FIGS. 1A, 1B. Also in the embodiment, a chemical mechanical polishing is performed in the polishing process. The polishing is performed till the substrate surface 15 of the transparent substrate 10 is exposed, and thereafter the substrate surface 15 of the transparent substrate 10 is also polished as little as possible.

Next, the surface protecting layer 30 is formed on the substrate surface 15 of the translucent substrate 10. In the embodiment, a metal oxide film such as a silicon oxide film, a metal nitride film such as a silicon nitride film, or the like is used as the surface protecting layer 30 to form the film on the substrate surface 15 by a CVD method or the like. As the result, the wire grid type polarization element 1 is completed in which the metal grid 20 is embedded in the groove like concave portions 11 formed on the substrate surface 15 of the translucent substrate 10 and the surface protecting layer 30 is formed on the substrate surface 15 of the translucent substrate 10.

### Effect of Present Embodiment

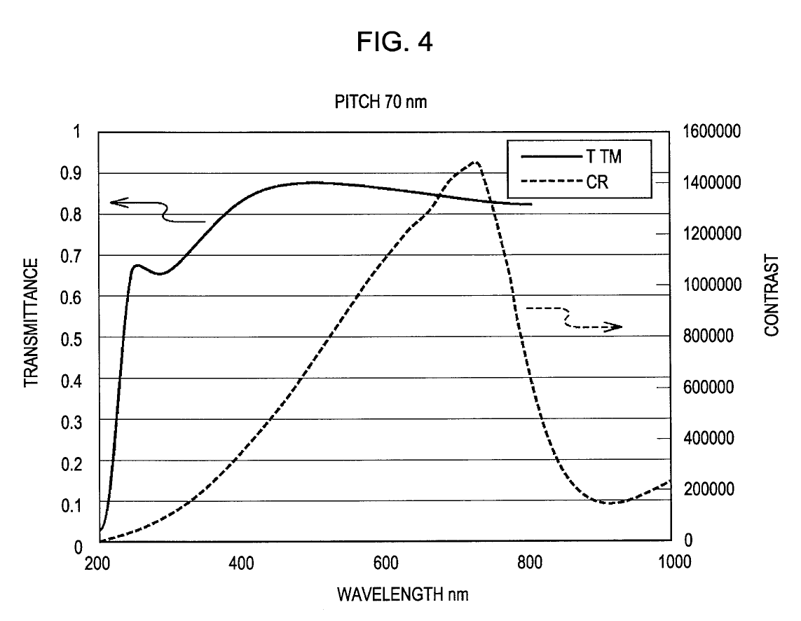

FIG. 4 is a graph showing transmittance property and contrast property of the wire grid type polarization element to which the invention is applied.

As described above, in the wire grid type polarization element 1 to which the invention is applied, a plurality of lines of groove concave portions 11 are formed on the substrate surface 15 of the translucent substrate 10 and the metal grid 20 is embedded in the plurality of lines of groove like concave portions 11. Accordingly, it is not necessary to form the metal grid 20 by etching a metal film. Consequently, the wide size and the pitch of the metal grid 20 are regulated by the width size and the pitch of the groove like concave portions 11 formed on the substrate surface 15 of the translucent substrate 10 and are not influenced by the etching accuracy to the metal film. Consequently, the width size of the metal grid 20 can be reduced to not more than 70 nm, for example, to 35 nm, and the pitch of the metal grid 20 can be reduced to not less than 140 nm, for example, to 70 nm.

Further, the thickness size of the metal grid 20 is regulated by the depth of the groove like concave portions 11 formed on the substrate surface 15 of the translucent substrate 10 and is not influenced by the accuracy of the film thickness when the metal film 21 is formed. Consequently it is also possible that the ratio of the thickness size and the width size of the metal grid 20 can be precisely set to, for example, 1:1.

Accordingly, the wire grid type polarization element 1 of the invention has transmittance property and contrast property as shown in FIG. 4, and the “transmittance” of the polarization component that vibrates in the direction perpendicular to the longitudinal direction of the metal grid 20 is not less than 80% over the entire range of the wavelength band of from 460 nm to 780 nm. Further, in the wire grid type polarization element 1 of the embodiment, the value (contrast) obtained by dividing the transmittance of the polarization component that vibrates in the direction perpendicular to the longitudinal direction of the metal grid 20 by the transmittance of the polarization component that vibrates in the direction parallel to the longitudinal direction of the metal grid 20 is not less than 170000 over the entire range of the wavelength band of from 460 nm to 780 nm.

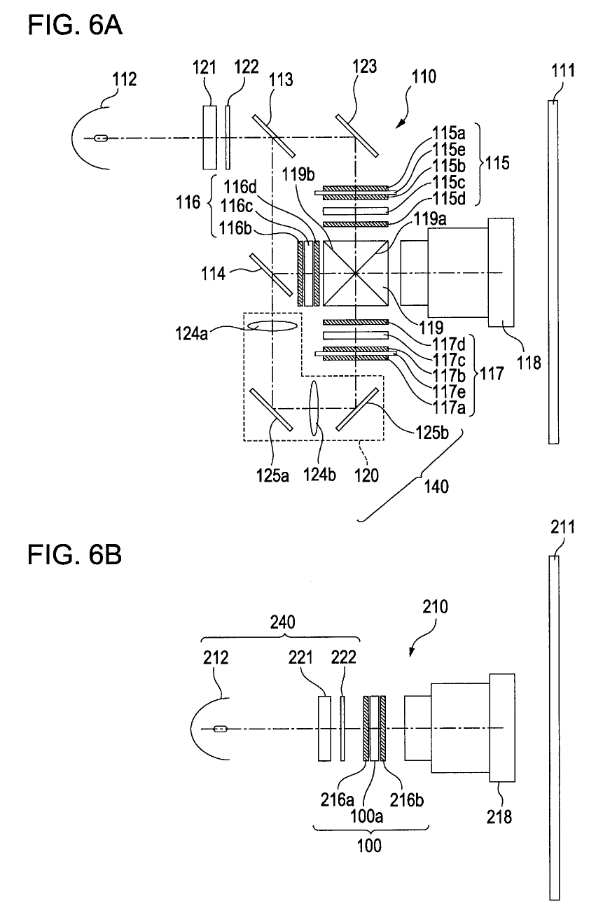

Accordingly, high transmittance can be obtained with respect to any color light of red (R), blue (B), and green (G) if a liquid crystal device is constituted by using the wire grid type polarization element 1 of the embodiment and the liquid crystal device is used as a color display unit of an electronic apparatus such as a mobile computer, a cellular phone, or the like, or the liquid crystal device is used for a light bulb of a projection type display apparatus for color display that will be described below with reference to FIGS. 6A, 6B. Consequently, a color image having high quality can be displayed.

Further, in the wire grid type polarization element 1 of the embodiment, the metal grid 20 is embedded in the plurality of lines of groove like concave portions 11 formed on the substrate surface 15. Accordingly, the substrate surface 15 is smooth. Consequently, a translucent protecting layer can be easily formed on the substrate surface 15 to have an even thickness.

### Another Wire Grid Type Polarization Element to Which Present Invention is Applied

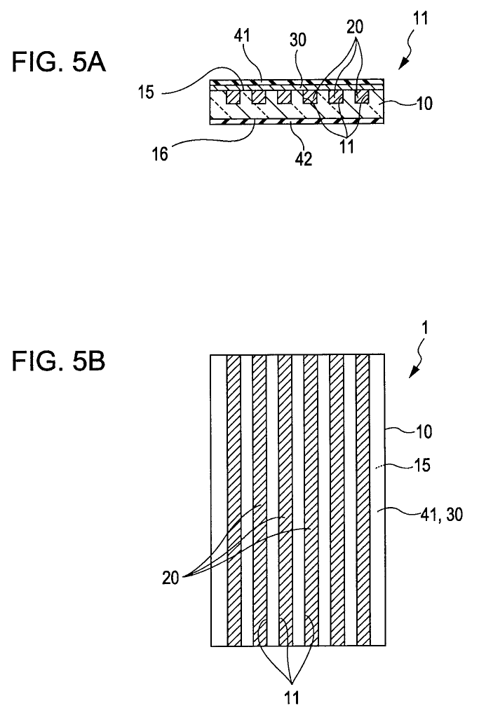

FIGS. 5A and 5B are a cross sectional view and a plan view schematically showing the structure of another wire grid type polarization element 1 to which the invention is applied.

In FIGS. 5A, 5B, the wire grid type polarization element 1 of the embodiment is equipped with a plurality of lines of metal grid 20 on the substrate surface 15 of the translucent substrate 10 made of a quartz glass, a heat resistance glass, or the like. The metal grid 20 is constituted by, for example, a single layer film or a multi layer film of silver, gold, copper, palladium, platinum, aluminum, rhodium, silicon, nickel, cobalt, manganese, iron, chrome, titanium, ruthenium, niobium, neodymium, ytterbium, yttrium, molybdenum, tungsten, indium, bismuth, or an alloy thereof.

In the wire grid type polarization element 1 of the embodiment, a plurality of lines of groove like concave portions 11 are formed along the metal grid 20 and the metal grid 20 is embedded in the plurality of lines of groove like concave portions 11. Consequently, in the wire grid type polarization element 1, the substrate surface 15 of the translucent substrate 10 constitutes a smooth surface in which both of areas in which the metal grid 20 is formed and areas in which the metal grid 20 is not formed are alternately continued. In addition, in the wire grid type polarization element 1 of the embodiment, the surface protecting layer 30 made of a metal oxide film such as a silicon oxide film or the like, a metal nitride film such as a silicon nitride film or the like, or the like is formed on the substrate surface 15 of the translucent substrate 10.

Further, in the embodiment, reflection preventing layers 41, 42 are formed on the both surface (the side of the substrate surface 15 and the side of a substrate surface 16) of the wire grid type polarization element 1. In the embodiment, the reflection preventing layers 41, 42 have a structure in which a silicon oxide film and a titanium oxide film are laminated by, for example, five layers.

The wire grid type polarization element 1 structured in this manner has excellent transmittance property. Further, in the wire grid type polarization element 1 of the embodiment, the metal grid 20 is embedded in the plurality of lines of groove like concave portions 11 formed on the substrate surface 15. Accordingly, the substrate surface 15 is smooth. Consequently, the translucent protecting layer and the reflection preventing layers 41, 42 can be easily formed on the substrate surface 15 to have an even thickness.

### Application Example to Projection Type Display Apparatus Projection Type Display Apparatus Having Three Light Bulbs

A projector (projection type display apparatus) that uses the liquid crystal devices 100 of the embodiment as light bulbs will be described with reference to FIGS. 6A, 6B. FIGS. 6A, 6B are each a configuration diagram schematically showing the projector.

The projector 110 shown in FIG. 6A is so called a projection type projector in which light is emitted to a screen 111 provided at the observer side and the light reflected by the screen 111 is observed. The projector 110 is equipped with a light source unit 140 equipped with a light source 112, dichroic mirrors 113, 114, a relay system 12, and the like, liquid crystal light bulbs 115 to 117 (liquid crystal device 100), a cross dichroic prism 119 (combining optical system), and a projection optical system 118.

The light source 112 is constituted by a supervoltage mercury lamp that supplies light including red light, green light, and blue light. The dichroic mirror 113 transmits red light and reflects green light and blue light emitted from the light source 112. Further, the dichroic mirror 114 transmits the blue light and reflects the green light among the green light and blue light reflected by the dichroic mirror 113. In this manner, the dichroic mirrors 113, 114 constitute a color separating optical system for separating the light emitted from the light source 112 into red light, green light, and blue light.

Herein, an integrator 121 and a polarization conversion element 122 are disposed between the dichroic mirror 113 and the light source 112 in series from the light source 112. The integrator 121 uniformizes the emission distribution of the light emitted from the light source 112. Further, the polarization conversion element 122 polarizes the light emitted from the light source 112 into, for example, s polarized light having a specific vibrating direction.

The liquid crystal light bulb 115 is a transmissive liquid crystal device that modulates the red light transmitted through the dichroic mirror 113 and reflected by a reflection mirror 123 in accordance with an image signal. The liquid crystal light bulb 115 is equipped with a λ/2 retardation film 115a, a first polarizer 115b, a liquid crystal panel 115c, and a second polarizer 115d. Herein, the red light introduced into the liquid crystal light bulb 115 is s polarized light without change as the polarization of light is not changed even when passed through the dichroic mirror 113.

The λ/2 retardation film 115a is an optical element that converts s polarized light introduced into the liquid crystal light bulb 115 into p polarized light. Further, the first polarizer 115b is a polarizer that blocks s polarized light and transmits p polarized light. Then, the liquid crystal panel 115c converts p polarized light into s polarized light (circular polarized light or elliptically-polarized light in the case of middle tone) by modulation in accordance with an image signal. Further, the second polarizer 115d is a polarizer that blocks p polarized light and transmits s polarized light. Accordingly, the liquid crystal light bulb 115 modulates the red light in accordance with an image signal and emits the modulated red light toward the cross dichroic prism 119.

Note that the λ/2 retardation film 115a and the first polarizer 115b are arranged so as to be made contact with a translucent glass plate 115e that does not convert polarization. This makes it possible to prevent the distortion of the λ/2 retardation film 115a and the first polarizer 115b caused by heat generation.

The liquid crystal light bulb 116 is a transmissive liquid crystal device that modulates the green ling reflected by the dichroic mirror 114 after reflected by the dichroic mirror 113 in accordance with an image signal. Then, the liquid crystal light bulb 116 is equipped with a first polarizer 116b, a liquid crystal panel 116c, and a second polarizer 116d similarly to the liquid crystal light bulb 115. The green light introduced into the liquid crystal light bulb 116 is s polarized light that is reflected by the dichroic mirrors 113, 114 to be introduced. The first polarizer 116b is a polarizer that blocks p polarized light and transmits s polarized light. Further, the liquid crystal panel 116c converts s polarized light into p polarized light (circular polarized light or elliptically-polarized light in the case of middle tone) by modulation in accordance with an image signal. Then, the second polarizer 116d is a polarizer that blocks s polarized light and transmits p polarized light. Accordingly, the liquid crystal light bulb 116 modulates the green light in accordance with an image signal and emits the modulated green light toward the cross dichroic prism 119.

The liquid crystal light bulb 117 is a transmissive liquid crystal device that modulates the blue light reflected by the dichroic mirror 113, transmitted through the dichroic mirror 114, and thereafter passed through a relay system 120 in accordance with an image signal. The liquid crystal light bulb 117 is equipped with a λ/2 retardation film 117a, a first polarizer 117b, a liquid crystal panel 117c, and a second polarizer 117d similarly to the liquid crystal light bulbs 115, 116. Herein, the blue light introduced into the liquid crystal light bulb 117 is reflected by the dichroic mirror 113, transmitted through the dichroic mirror 114, and thereafter reflected by two reflection mirrors 125a, 125b of the relay system 120 described below. Accordingly, the blue light introduced into the liquid crystal light bulb 117 is s polarized light.

The λ/2 retardation film 117a is an optical element that converts s polarized light introduced into the liquid light bulb 117 into p polarized light. Further, the first polarizer 117b is a polarizer that blocks s polarized light and transmits p polarized light. The liquid crystal panel 117c converts p polarized light into s polarized light (circular polarized light or elliptically-polarized light in the case of middle tone) by modulation in accordance with an image signal. Further the second polarizer 117d is a polarizer that blocks p polarized light and transmits s polarized light. Accordingly, the liquid crystal light bulb 117 modulates the blue light in accordance with an image signal and emits the modulated blue light toward the cross dichroic prism 119. Note that the λ/2 retardation film 117a and the first polarizer 117b are disposed so as to be made contact with a glass plate 117e.

The relay system 120 is equipped with relay lenses 124a, 124b and the reflection mirrors 125a, 125b. The relay lenses 124a, 124b are provided to prevent optical loss caused by the long optical path of the blue light. Herein, the relay lens 124a is disposed between the dichroic mirror 114 and the reflection mirror 125a. Further, the relay lens 124b is disposed between the reflection mirrors 125a, 125b. The reflection mirror 125a is disposed so as to reflect the blue light transmitted through the dichroic mirror 114 and emitted from the relay lens 124a toward the relay lens 124b. Further, the reflection mirror 125b is disposed so as to reflect the blue light emitted from the relay lens 124b toward the liquid crystal light bulb 117.

The cross dichroic prism 119 is a color composition optical system in which two dichroic films 119a, 119b are perpendicularly disposed to form X character shape. The dichroic film 119a is a film that reflects blue light and transmits green light, and the dichroic film 119b is a film that reflect red light and transmits green light. Accordingly, the cross dichroic prism 119 combines the red light, green light, and blue light respectively modulated by the liquid crystal light bulbs 115 to 117 and emits the combined light toward the projection optical system 118.

Note that the light introduced into the cross dichroic prism 119 from the liquid crystal light bulbs 115, 117 is s polarized light and the light introduced into the cross dichroic prism 119 from the liquid crystal light bulb 116 is p polarized light. In this manner, the light introduced into the cross dichroic prism 119 is light having a different type of polarization. Accordingly, the light introduced from each liquid crystal light bulbs 115 to 117 can be effectively combined by the cross dichroic prism 119. Herein, the dichroic films 119a, 119b generally have excellent reflection property to s polarized light. Accordingly, the red light and the blue light reflected by the dichroic films 119a, 119b are set to s polarized light and the green light transmitted through the dichroic films 119a, 119b is set to p polarized light. The projection optical system 118 has a projection lens (omitted in FIG. 6A) and projects the light combined by the cross dichroic prism 119 onto the screen 111.

High transmittance can be obtained to any color light of red (R), green (G), and blue (B) if the wire grid type polarization element 1 to which the invention is applied is used as the first polarizer 115b, the second polarizer 115d, the first polarizer 116b, the second polarizer 116d, the first polarizer 117b, and the second polarizer 117d in the projector 110 structured in this manner. Accordingly, even when polarizers having the same structure are used as the first polarizer 115b, the second polarizer 115d, the first polarizer 116b, the second polarizer 116d, the first polarizer 117b, and the second polarizer 117d, a color image having high quality can be displayed.

### Projection Type Display Apparatus Having One Light Bulb

In a projector 210 (projection type display apparatus) shown in FIG. 6B, a color image is displayed on a screen 211 by projection by one liquid crystal liquid device 100. That is, the projector 210 is equipped whit a light source unit 240 equipped with a white light source 212, an integrator 221, and a polarization converting element 222, the liquid crystal device 100, and a projection optical system 218. Note that, in the liquid crystal device 100, a first polarizer 216a and a second polarizer 216b are disposed at the both sides of a liquid crystal panel 100a in which a color filter is incorporated.

In the projector 210 structured in this manner, high transmittance can be obtained to any color light of red (R), green (G), and blue (B) if the wire grid type polarization element 1 to which the invention is applied is used as the first polarizer 216a and the second polarizer 216b. Accordingly, a color image having high quality can be displayed.

The entire disclosure of Japanese Patent Application No. 2007-192990, filed Jul. 25, 2007 is expressly incorporated by reference hereby.

What is claimed is:

1. A wire grid type polarization element equipped with a plurality of lines of metal grid on a translucent substrate, wherein
a plurality of lines of groove like concave portions are formed on the substrate, and
the metal grid is embedded in the plurality of lines of groove like concave portions.

2. The wire grid type polarization element according to claim 1, wherein
transmittance of a polarization component that vibrates in a direction perpendicular to a longitudinal direction of the metal grid is not less than 80% over the entire range of a wavelength band of from 460 nm to 780 nm.

3. The wire grid type polarization element according to claim 1, wherein
a translucent protecting layer is formed on the substrate.

4. The wire grid type polarization element according to claim 1, wherein
a reflection preventing layer is formed on at least one of both side of the translucent substrate.

5. A manufacturing method of a wire grid type polarization element equipped with a plurality of lines of metal grid on a translucent substrate, the manufacturing method comprising:
forming an etching mask equipped with groove like openings on the substrate, the groove like openings being provided in areas in which the metal grid should be formed;
forming groove like concave portions in areas overlapping with the groove like openings on the substrate by subjecting the substrate to an etching treatment;
embedding a metal film that should form the metal grid in the groove like concave portions; and
leaving the metal film in the groove like concave portions whereas removing the metal film protruded from the groove like concave portions by subjecting the substrate to a polishing treatment.

6. The manufacturing method of a wire grid type polarization element according to claim 5, wherein
the etching mask is formed by performing exposure and development after a photosensitive resin is applied on the substrate.

7. The manufacturing method of a wire grid type polarization element according to claim 5, wherein a mask material layer is formed on the substrate, and thereafter a die surface of a mold member equipped with projections at portions corresponding to the groove like openings is pressed to the mask material layer to transfer a formation pattern of the projections to the mask material layer, thereby forming the etching mask in which thicknesses of the groove like portions are reduced.

8. The manufacturing method of a wire grid type polarization element according to claim 5, wherein
a chemical mechanical polishing treatment is performed as the polishing treatment.

9. A liquid crystal device comprising the wire grid type polarization element according to claim 1.

10. A projection type display apparatus using the liquid crystal device according to claim 9, comprising:
a light source unit for introducing light into the liquid crystal device; and
a projection optical system for expansively projecting light optically modulated by the liquid crystal device.
